(19) United States
(12) Patent Application Publication
(10) Pub. No.: US 2026/0019813 A1
(43) Pub. Date: Jan. 15, 2026

(54) METHOD AND SYSTEM FOR CONNECTED VEHICLES VIA BLOCKCHAIN

(71) Applicant: Mastercard International Incorporated, Purchase, NY (US)

(72) Inventors: David VORHIES, St. Charles, MO (US); Shawn MEHRHOFF, St. Ann, MO (US); Christopher T. SCHOLL, 63021, MO (US)

(73) Assignee: Mastercard International Incorporated, Purchase, NY (US)

(21) Appl. No.: 18/766,840

(22) Filed: Jul. 9, 2024

(51) Int. Cl. H04W 12/50; G07C 5/00; H04M 1/72409

(52) U.S. Cl. CPC H04W 12/50; G07C 5/008; H04M 1/724098

(57) ABSTRACT

A method for data exchange between vehicles using blockchain includes: storing, in a first vehicle, a blockchain comprised of a plurality of blocks; broadcasting, by the first vehicle, an identification signal including a make and model of the first vehicle; receiving, by in the first vehicle, updated blockchain data from a second vehicle including one or more new blocks for the blockchain; updating, by the first vehicle, the stored blockchain based on the updated blockchain data; determining, by the first vehicle, that the updated blockchain data includes a new blockchain data entry including a notification associated with the make and model of the first vehicle; and transmitting, by the first vehicle, the notification to a user interface device causing the user interface device to display the notification to a user.

### FIELD

The present disclosure relates to the connection of vehicles via a blockchain, specifically the use of blockchains to store data for use by vehicles that can be exchanged using direct communication between vehicles.

### BACKGROUND

Millions of car accidents occur every year from a variety of different causes. As a result, car and other vehicle manufacturers place a high priority on safety features and ensuring every vehicle is roadworthy. At the same time, governments and other regulatory agencies pass and enforce rules and regulations regarding access to and use of safety features in vehicles, as well as numerous laws regarding the operation of vehicles, to further increase the safety of drivers, passengers, and passersby. Car manufacturers ensure that all vehicles comply with all applicable rules and regulations and often go above and beyond requirements for added safety and protection.

However, there are rare occasions where a vehicle is manufactured, shipped, and sold to a driver with a defect. When such a defect is identified, the manufacturer typically issues a recall, inviting the affected vehicle owners to take their vehicle to an authorized agent to address the defect through repair, replacement, or other remedial action. Unfortunately, it can be exceedingly difficult for manufacturers to provide adequate notice to vehicle owners that a recall has been issued. Recall notices are mostly manual processes and typically require the vehicle manufacturers to identify mailing addresses for vehicle owners to which to send a recall notice. However, there are no central databases with addresses of vehicle ownership, and maintaining such information can be exceedingly difficult with the regular resale of vehicles, moving of vehicle owners, and vehicle registrations occurring using different systems and different timelines across different jurisdictions.

A solution to such a problem could be to provide recall notices to the vehicles themselves. Some vehicles are equipped with Internet-connected systems to receive data via the Internet using satellite or cellular networks. However, such technology can be prohibitively expensive, only effective in certain geographic locations, is unavailable on a vast majority of vehicles with limited options for upgrading and can be subject to tampering and interference. Thus, there is a need for a technological system to enable vehicles to directly exchange data with one another for the distribution of recall notices, software updates, and other useful information.

### SUMMARY

The present disclosure provides a description of systems and methods for data exchange between vehicles using blockchain. A blockchain can be used to maintain data regarding vehicles and, in particular, can be used to store recall notices and other information that is to be distributed to vehicle owners for specific vehicles. A vehicle can be equipped with a computing device, which can be a part of existing vehicle computers, entertainment systems, and the like or interfaced therewith, such as through a user device of the driver or passenger of a vehicle. The vehicle's computing device can store a local copy of the blockchain in a memory thereof. While in operation, the computing device can broadcast a signal to other vehicles located nearby. Other vehicles can receive the signal and respond to the signal with updates to the first vehicle's blockchain data. The use of a timestamp, make and model of the first vehicle, or other data in the broadcast signal can be used to ensure that the other vehicles only provide a response when there are actual updates with respect to the blockchain or the particular make and model of the first vehicle. Alternatively, or additionally, when identifying make and model, the identity of a blockchain that is dedicated to a particular make, certain makes, certain makes and certain models, make and model, specific sets of Vehicle Identification Numbers (VINs) or other permutations of this information or whatever other identifying information like this that is associated with the vehicle at the time of transmission of the notice, may be used. This is particularly appropriate when a notice is to common aspects or components and the like of a variety of vehicle makes and models, e.g., defective airbags, or whatever other data that can be used to identify at least make and model known to the vehicle at the time of transmission of the notice. The vehicle can receive the updates to the blockchain data, update its local storage, and determine if the updates include any applicable notices, such as a recall notice that affects the make and model of the vehicle. When such a notice is included in the updated data, it can be displayed to the driver and/or vehicle owner via a user interface display, immediately providing notice of the recall or other information. The result is that up to all vehicles can be quickly apprised of any recall notices or other information by other vehicles, which can utilize short forms of communication, and without the need for slow, labor intensive, and ineffectual mailing practices of traditional systems. By using a blockchain to convey the data, the data and notices can be secure from tampering and fraud to ensure successful and secure vehicle-to-vehicle data exchange.

A method for data exchange between vehicles using blockchain includes: storing, in a memory of a computing device in a first vehicle, a blockchain comprised of a plurality of blocks; broadcasting, by a transmitter of the computing device in the first vehicle, an identification signal, the identification signal including data identifying at least a make and model of the first vehicle; receiving, by a receiver of the computing device in the first vehicle, updated blockchain data from a second vehicle, the updated blockchain data including one or more new blocks for the blockchain; updating, by a processor of the computing device in the first vehicle, the stored blockchain based on the updated blockchain data; determining, by the processor of the computing device in the first vehicle, that the updated blockchain data includes a new blockchain data entry including a notification associated with the make and model of the first vehicle; and transmitting, by the transmitter of the computing device in the first vehicle, the notification to a user interface device causing the user interface device to display the notification to a user.

A system for data exchange between vehicles using blockchain includes: a first vehicle; a second vehicle; and a user interface device, wherein the first vehicle includes computing device, the computing device comprising a memory storing a blockchain comprised of a plurality of blocks, a transmitter broadcasting an identification signal, the identification signal including data identifying at least a make and model of the first vehicle, a receiver receiving updated blockchain data from the second vehicle, the updated blockchain data including one or more new blocks for the blockchain, a processor updating the stored blockchain based on the updated blockchain data, and determining that the updated blockchain data includes a new blockchain data entry including a notification associated with the make and model of the first vehicle, wherein the transmitter of the computing device of the first vehicle further transmits the notification to the user interface device causing the user interface device to display the notification to a user.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for data exchange between vehicles using blockchain in accordance with exemplary embodiments.

FIG. 2 is a block diagram illustrating a computing system of a vehicle in the system of FIG. 1 for data exchange between vehicles using blockchain in accordance with exemplary embodiments.

FIGS. 3A and 3B are a flow diagram illustrating a process for the distribution of blockchain data to vehicles and the exchange of blockchain data between vehicles in the system of FIG. 1 in accordance with exemplary embodiments.

FIG. 4 is a flow chart illustrating an exemplary method for data exchange between vehicles using blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Data Exchange Between Vehicles Using Blockchain

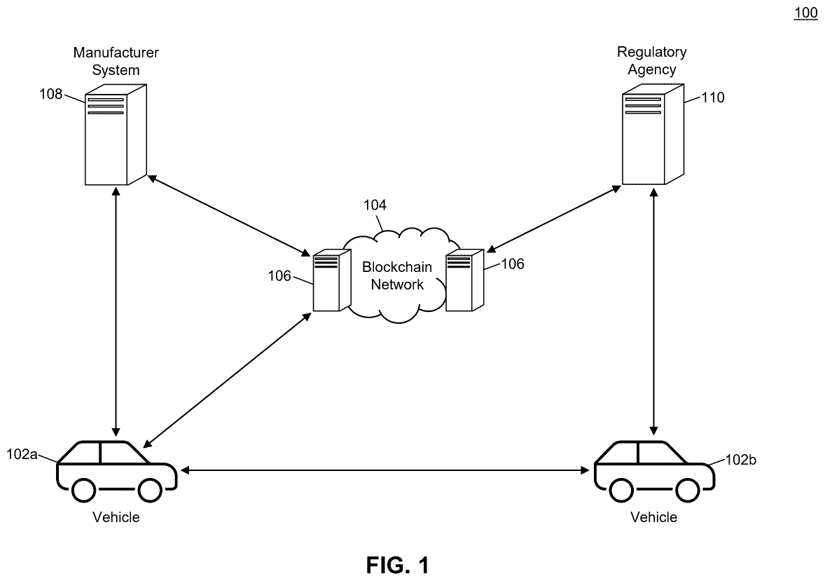

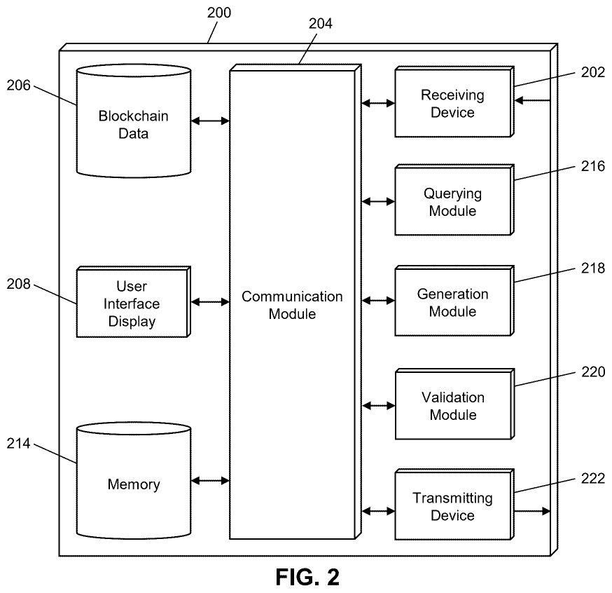

FIG. 1 illustrates a system 100 for the exchange of blockchain data between vehicles. The system 100 can include vehicles 102, illustrated in FIG. 1 with a first vehicle 102 and a second vehicle 102b. Each vehicle 102 can include a computing device, such as the computing device 200 illustrated in FIG. 2 and discussed in more detail below. The computing device can be physically implemented in the vehicle 102, such as an onboard computing system, part of an entertainment system, as part of a global positioning system device or other navigation system, etc. In some cases, “computing device” as used herein with respect to vehicles 102 can refer to a device in the vehicle that communicates with an additional device, such as a smart phone or other device, possessed by a user of the vehicle 102, such as a driver, where functions performed by the computing device of the vehicle 102 can be performed by the computing system of the vehicle itself or the external device in communication with the vehicle itself. As used herein, “vehicle” can refer to the physical vehicle or the computing device of the vehicle. While the vehicles 102 are illustrated in FIG. 1 as automobiles, vehicle 102 can refer to any type of motor vehicle that can be equipped with a computing device as discussed herein for exchanging blockchain data with other vehicles 102.

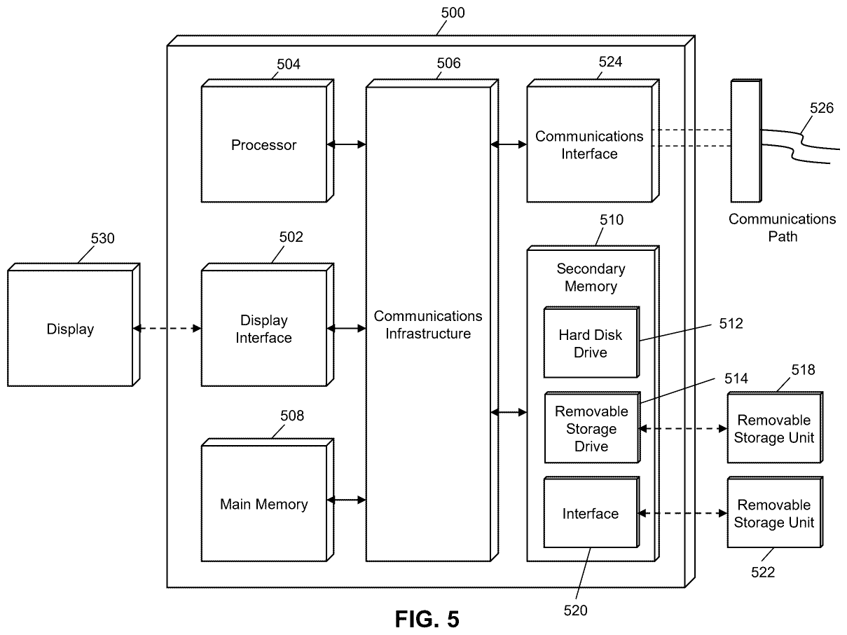

The system 100 can also include a blockchain network 104. The blockchain network 104 can be comprised of a plurality of blockchain nodes 106. Each blockchain node 106 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in a blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of currency generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

In the system 100, a blockchain can be used for storing vehicle data, specifically notifications for a vehicle owner and/or operator. In some cases, a blockchain network 104 can operate a single blockchain for all data. In other cases, a blockchain network 104 can operate separate blockchains for different types of vehicles, such as a unique blockchain for each vehicle manufacturer, a unique blockchain for each vehicle make and model, a unique blockchain for vehicles of a specific manufacture year, etc. In some instances, separate blockchains can each be managed by separate blockchain networks 104, which can have distinct and separate blockchain nodes 106 or can share one or more blockchain nodes 106 in common. In some embodiments, the computing device of each vehicle 102 can be a blockchain node 106.

Each vehicle 102 can store a local copy of the blockchain in a memory thereof. When a vehicle 102 can establish a communication channel with a blockchain node 106, the vehicle 102 can receive updated blockchain data and update its local copy of the blockchain node to include all blocks that were added to the blockchain since its local copy was last updated. For vehicles 102 that are capable of Internet, cellular, or other long-range communication methods, the vehicle 102 can connect to a blockchain node 106 over the Internet or other long-range communication method and request the updated blockchain data, such as by providing a timestamp corresponding to the last update received that was used for the local copy of the blockchain. The blockchain node 106 can receive the timestamp, identify all blocks added to the blockchain since the time indicated in the timestamp, and provide the added blocks to the vehicle 102 for use in updating its local copy of the blockchain.

For vehicles 102 without long-range communication capabilities, the vehicle 102 can be configured to exchange data with other vehicles 102 using a suitable communication method. Such communication methods can include any type of communication that is directly between both vehicles 102, such as using radio frequency, Bluetooth, etc. The use of such communication methods can ensure that a vehicle 102 can receive updates of the blockchain even in locations where Internet or cellular communications are unavailable, such as in rural areas, underground parking structures, etc. Such communication methods can also be implemented in older vehicles more easily and at a significantly lower expense than equipping vehicles with computing devices capable of Internet or cellular communications.

In the system 100, a first vehicle 102a can have an updated copy of the blockchain via Internet-based communication with a blockchain node 106. A second vehicle 102b may lack the ability to communicate directly with a blockchain node 106 not based in another vehicle 102 and require updates to its local copy of the blockchain. To initiate a data exchange, the second vehicle 102b can broadcast a signal while in operation using a suitable communication method. The broadcast signal can include a notification that updated blockchain data is requested and, in some instances, can include one or more criteria that can affect the data exchange. In one example, the broadcast signal can include the timestamp of the last update to the local copy of the blockchain data for the second vehicle 102b. In such an example, the first vehicle 102a can receive the signal and if its local copy of the blockchain does not include any new blocks added since the timestamp included in the broadcast signal, can ignore the signal and not respond. If the first vehicle's local copy of the blockchain is outdated based on the timestamp in the broadcast signal, the first vehicle 102a can request an update to its own copy of the blockchain from the second vehicle 102b, which can be provided in the manner discussed below. In another example, the broadcast signal can include the make and model of the second vehicle 102b. Alternatively or additionally, when identifying a make and model, the identity of a blockchain that is dedicated to a make, certain makes, certain makes and certain models, make and model, specific sets of Vehicle Identification Numbers (VINs) or other permutations of this information or whatever other identifying data that is associated with and known to the vehicle at the time of transmission of the notice may be used. In such an example, each vehicle 102 may store only the blockchain or those blocks in the blockchain that include blockchain data entries directly applicable to the make or model of that vehicle 102. If the first vehicle 102a receives the broadcast signal and identifies that the second vehicle 102b is of a different make and model, the first vehicle 102a can ignore the signal and not respond. If the first vehicle 102a receives the broadcast signal and determines that it is of the same make and model as the second vehicle 102b, the first vehicle 102a may respond.

When the first vehicle 102a receives the broadcast signal and determines that it will respond to the signal (e.g., it has updated, applicable blockchain data), the first vehicle 102a can identify any applicable blocks in its local copy of the blockchain and electronically transmit a data message to the second vehicle 102b that includes the applicable blocks using the suitable communication method. In some cases, the first vehicle 102a and second vehicle 102b can establish a communication channel prior to such a transmission using suitable methods. The applicable blocks can be any blocks that were added to the blockchain since the second vehicle's last update to its local copy, such as can be identified by the first vehicle 102a based on a timestamp included in the broadcast signal or other data, such as a direct request submitted by the second vehicle 102b after a communication channel is established or in response to a query message from the first vehicle 102a requesting a timestamp.

The second vehicle 102b can receive the updated blockchain data that includes the new blocks and update its local copy of the blockchain with the new blocks. In some cases, the updating of the local copy can include the generation and storage of a timestamp, which can correspond to the time when the local copy was updated, a time that the newest block of the added blocks was added to the blockchain, or a time provided by the first vehicle 102a to which its local copy of the blockchain corresponds. The second vehicle 102b can go through the new blocks to determine if any of the new blocks include a blockchain data entry that has a notification that is applicable to the second vehicle 102b, such as a recall notice that applies to the make and model of the second vehicle 102b. If no notification is identified, then the second vehicle 102b can operate as normal. In some cases, the second vehicle 102b can display a message via a user interface display (e.g., to a driver, passenger, the vehicle owner, etc.) that its local copy of the blockchain was updated. In some such cases, the message can indicate that no notifications for the second vehicle 102b have been received.

If the second vehicle 102b determines that a new block is applicable to the second vehicle 102b, the second vehicle 102b can display the notification in the applicable block via the user interface display. In some cases, the user interface display can be a display that is physically located in the vehicle 102, such as on an entertainment system, as part of a heads up display, as part of a navigation display, etc. In other cases, the user interface display can be part of a separate device that is in communication with a computing device physically implemented as part of the vehicle 102. For example, the user interface display can be a smart phone in communication with a computing device of the vehicle 102, such as using Bluetooth. In such an example, the notification can be displayed on the smart phone via a push notification, short messaging service message, or other suitable method. The vehicle owner or other suitable party can then be apprised of the notification that affects the second vehicle 102b automatically without any activity being performed by the vehicle owner or operator.

The system 100 can be used to quickly, accurately, and securely notify vehicle owners and operators of potentially important information regarding a vehicle 102, such as recall notices. In an example, a vehicle manufacturer, represented in FIG. 1 as manufacturer system 108, which as herein can refer to the vehicle manufacturer or one or more computing systems that perform functions on behalf of the vehicle manufacturer with respect to the system 100, for a specific make an model vehicle may determine that a recall is appropriate for a part of that make and model vehicle due to a safety concern. The manufacturer system 108 can generate a notification regarding the recall that can include the recalled part and information for having the recalled part replaced or serviced, such as a uniform resource locator (URL) for a website that can be visited to find an authorized entity to replace or service the recalled part. The manufacturer system 108 can submit the notification and the make and model to which it applies to a blockchain node 106 using a suitable communication network and method. The blockchain node 106 can include the notification, make, and model in a new blockchain data entry that included in a new block that is confirmed and added to the blockchain using traditional methods. The new block can be distributed to vehicles 102 using the methods discussed herein, where a vehicle 102 of that make and model will identify the notification as being applicable, and display the notification, enabling the vehicle owner or operator to quickly address the recall. The system 100 can similarly be used to notify vehicles 102 of updates to system software and, in some cases, can include the program code or software updates in the notifications to be used and/or executed by the vehicles 102.

In some embodiments, the blockchains discussed herein can be used to store additional vehicle data. For instance, a blockchain can be used to store information regarding the operation, ownership, maintenance, etc. of a vehicle 102. In such an instance, when a vehicle 102 is manufactured, the manufacturer system 108 can submit vehicle data for the vehicle 102 to a blockchain node 106 for addition to the blockchain. The vehicle data can include, for example, a vehicle identification number (VIN), make, model, trim, place of manufacture, port of entry, and any other suitable data. When new data regarding the vehicle 102 is obtained, the blockchain can be updated with a new blockchain data entry for the vehicle 102 that includes the VIN or other identification value as well as new or updated data. For instance, when the vehicle 102 is sold, a dealership or private party that sells the vehicle 102 can submit information regarding the new owner, mileage of the vehicle 102, etc., where the change in owner and updated information can be added to the blockchain.

In another example, when the vehicle owner registers the vehicle 102 with a regulatory agency 110, the regulatory agency 110 can add the registration information to the blockchain, such as the vehicle owner's name, registered address for the vehicle 102, insurance company name and policy that covers the vehicle 102, current odometer reading for the vehicle 102, number for the license plate issued for the vehicle 102, etc. In yet another example, any services or repairs performed on the vehicle 102 can be added to the blockchain as well by the mechanic or other service provider that performed the service. In such an instance, the immutable record of the service of the vehicle 102 can ensure that a potential buyer of the vehicle 102 cannot be fraudulently misled by a seller as to the history of the vehicle. Additionally, the vehicle 102 itself can monitor for the performance of service and can notify the vehicle owner or operator, via the user interface display, when a service is appropriate. For instance, if the vehicle 102 passes a threshold (e.g., of mileage, time, etc.) without an update to its local copy of the blockchain that includes a new blockchain data value that indicates a service performed on the vehicle 102, the vehicle 102 can notify the vehicle owner or operator that the vehicle 102 is due for service.

In these embodiments, the storage of vehicle data on the blockchain and the exchange of data between vehicles 102 ensures that relevant vehicle data is kept up to date and securely stored in an accessible location. In addition to ensuring fast and accurate notification of recall notices and other information, this can enable vehicle manufacturers and regulatory agencies to collect useful data regarding the operation of vehicles 102. For instance, a vehicle manufacturer can identify if its vehicles are being adequately serviced and obtain information regarding accidents and other incidents of manufactured vehicles for use in maintaining a high level of safety.

In some embodiments, notifications can be added to the blockchain that are applicable to a specific vehicle 102. In such embodiments, a notification can be added to the blockchain that includes a unique identifier associated with a specific vehicle 102, such as the vehicle's VIN. In such an embodiment, when the local copy of the blockchain is updated by the vehicle 102 that is associated with that unique identifier, the vehicle 102 can display the notification. Such notifications can be used to provide specialized notifications, such as for vehicles 102 that are subject to a recall notice that have not yet been services, to vehicles 102 whose service is significantly overdue, with specific locations where a vehicle 102 can be taken for a service, etc.

The methods and systems discussed herein provide for the exchange of blockchain data between vehicles that can be used for the automated and efficient distribution of vehicle notices, such as recall notices. By using direct communication between vehicles, notifications can be quickly disseminated across up to all vehicles without the need for sophisticated communication systems that use Internet or cellular communications and in areas where such communication can be difficult or unavailable. A single vehicle that obtains an updated copy of the blockchain can quickly distribute the updated copy to hundreds of thousands of other vehicles through broadcasts and transmissions, where such data exchanges can occur at traffic lights, gas stations, parking garages, airports, hotels, etc. The result is that a vehicle manufacturer or other party can quickly, efficiently, and automatically reach up to all applicable vehicle owners significantly faster and more conveniently than existing systems. In addition, the use of a blockchain to store the data ensures that the data is secure and protected from fraud and tampering, to ensure the trustworthiness of notifications being displayed to vehicle owners.

### Computing Device

FIG. 2 illustrates an embodiment of a computing device 200. The computing device 200 can be the computing device of a vehicle 102 in the system 100 of FIG. 1. It will be apparent to persons having skill in the relevant art that the embodiment of the computing device 200 illustrated in FIG. 2 is provided as illustration only and cannot be exhaustive to all possible configurations of the computing device 200 suitable for performing the functions as discussed herein. For example, the computer system 500 illustrated in FIG. 5 and discussed in more detail below can be a suitable configuration of the computing device 200.

The computing device 200 can include a receiving device 202. The receiving device 202 can be configured to receive data over one or more networks via one or more network protocols. In some instances, the receiving device 202 can be configured to receive data from other computing devices 200, blockchain nodes 106, manufacturer systems 108, regulatory agencies 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by other vehicle computing devices 200 that are superimposed or otherwise encoded with requests for updated blockchain data, timestamps, make and model data, etc. The receiving device 202 can also be configured to receive data signals electronically transmitted by blockchain nodes 106, which can be superimposed or otherwise encoded with blockchain data. The receiving device 202 can also be configured to receive data signals electronically transmitted by manufacturer systems 108, regulatory agencies 110, and other systems that can be superimposed or otherwise encoded with vehicle data, requests for vehicle data, updated blockchain data, etc.

The computing device 200 can also include a communication module 204. The communication module 204 can be configured to transmit data between modules, engines, databases, memories, and other components of the computing device 200 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the computing device 200 and external components of the computing device 200, such as externally connected databases, display devices, input devices, etc. The computing device 200 can also include a processing device. The processing device can be configured to perform the functions of the computing device 200 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The computing device 200 can also include blockchain data 206, which can be stored in a memory 214 of the computing device 200 or stored in a separate area within the computing device 200 or accessible thereby. The blockchain data 206 can include a blockchain, which may be comprised of a plurality of blocks and be associated with the blockchain network 104 and a blockchain. In some cases, the blockchain data 206 can further include any other data associated with the blockchain and management and performance thereof, such as block generation algorithms, digital signature generation and confirmation algorithms, communication data for blockchain nodes 106, smart contracts, cryptographic keys, etc.

The computing device 200 can also include a user interface display 208. The user interface display 208 can be configured to display data, such as messages, notifications, images, videos, etc. The user interface display 208 can utilize a display device that is implemented as part of the computing device 200 or can utilize a display device external to the computing device 200 and in communication therewith, such as can be part of a separate computing device. The user interface display 208 can be configured to, for example, display notifications, such as recall notifications, to an owner or operator of a vehicle 102 as identified in updated blockchain data received via the methods discussed herein.

The computing device 200 can also include a memory 214. The memory 214 can be configured to store data for use by the computing device 200 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the computing device 200 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, device profiles, device profile data, configuration keys, cryptographic keys including public keys and/or private keys, communication data, blockchain algorithms and data, vehicle data, etc.

The computing device 200 can include a querying module 216. The querying module 216 can be configured to execute queries on databases to identify information. The querying module 216 can receive one or more data values or query strings and can execute a query string based thereon on an indicated database, such as the blockchain data 206 of the computing device 200 to identify information stored therein. The querying module 216 can then output the identified information to an appropriate engine or module of the computing device 200 as necessary. The querying module 216 can, for example, execute a query on the blockchain data 206 to identify new blocks added to the blockchain subsequent to a time indicated by a timestamp in a message broadcast by another vehicle 102.

The computing device 200 can also include a generation module 218. The generation module 218 can be configured to generate data for use by the computing device 200 in performing the functions discussed herein. The generation module 218 can receive instructions as input, can generate data based on the instructions, and can output the generated data to one or more modules of the computing device 200. For example, the generation module 218 can be configured to generate blockchain data entries, blocks, encryption keys, device profiles, request messages, notifications, blockchain data updates, vehicle data updates, broadcast signals, etc.

The computing device 200 can also include a validation module 220. The validation module 220 can be configured to perform data validations and verifications for the computing device 200 as part of the functions discussed herein. The validation module 220 can receive instructions as input, can perform data validations or verification as instructed, and can output a result of the data validations or verifications to one or more modules of the computing device 200. In some cases, the input can include the data to be validated or verified and/or data to be used in the validation or verification. In other cases, the validation module 220 can be configured to identify such data, such as in the blockchain data 206 and/or memory 214. The validation module 220 can be configured to, for example, validate new blockchain data entries and/or blocks, verify digital signatures, validate device profile data, verify successful encryptions, verify configuration key or cryptographic key authenticity, etc. For instance, the validation module 220 can validate that a blockchain data entry is applicable to the vehicle 102 of the computing device 200 based on an included VIN, make and model, or other data corresponding to the vehicle 102, such as based on vehicle data stored in the memory 214.

The computing device 200 can also include a transmitting device 222. The transmitting device 222 can be configured to transmit data over one or more networks via one or more network protocols. In some instances, the transmitting device 222 can be configured to transmit data to other vehicles 102, blockchain nodes 106, manufacturer systems 108, regulatory agencies 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 224 can be configured to electronically transmit data signals to other vehicles 102 that can be superimposed or otherwise encoded with broadcast messages, timestamps, make and model data, vehicle data, requests for blockchain data, updated blockchain data, etc. The transmitting device 224 can also be configured to electronically transmit data signals to blockchain nodes 106, which can be superimposed or otherwise encoded with requests for blockchain data, updated vehicle data, etc. The transmitting device 224 can also be configured to electronically transmit data signals to manufacturer systems 108, regulatory agencies 110, and other systems that can be superimposed or otherwise encoded with requests for blockchain data, updated vehicle data, requests for vehicle data, requests for service data, etc.

### Process for Blockchain Data Exchange Between Vehicles

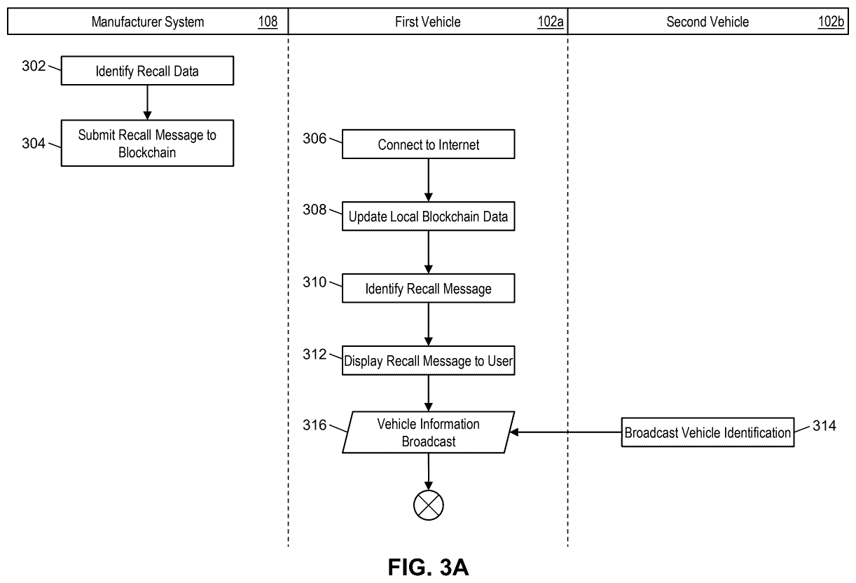

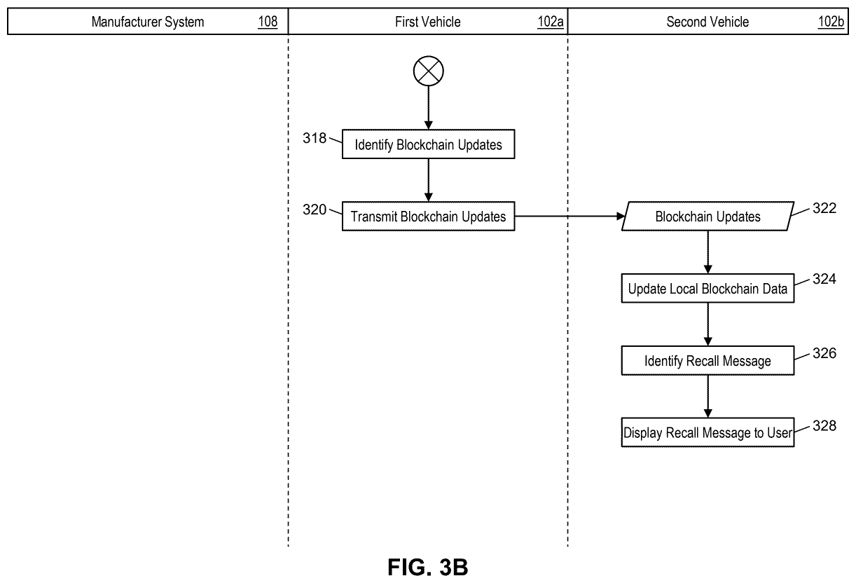

FIGS. 3A and 3B illustrates a process in the system 100 of FIG. 1 for the secure exchange of a vehicle recall notice stored in a blockchain between two vehicles.

In step 302, a manufacturer system 108 for a vehicle manufacturer that manufactured a first vehicle 102a and a second vehicle 102b can identify that a recall could or needs to be issued for a specific part for the make and model of the first vehicle 102a and the second vehicle 102b. In order to distribute information regarding the recall to vehicle owners of the first vehicle 102a and the second vehicle 102b, the manufacturer system 108 can, in step 304, submit a recall notification message to a blockchain node 106 in a blockchain network 104 that operates a blockchain for the make and model of vehicle. The recall notification message can include information on the specific part, the nature of the recall, and information on how a vehicle owner or operator can have the specific part replaced or serviced. The blockchain node 106 can include the recall notification message in a new block that is added to the blockchain using traditional methods.

In step 306, the first vehicle 102a can connect to the Internet. The first vehicle 102a can have a computing device 200 that has hardware that is capable of and configured to connect to the Internet using a suitable method. Once connected, the first vehicle 102a can, in step 308, request and receive an updated copy of the blockchain from a blockchain node 106. The first vehicle 102a can request up to all blocks added to the blockchain since its last update, receive the new blocks from the blockchain node 106, and then update its local copy of the blockchain stored in the blockchain data 206 of the computing device 200 with the received blocks. In step 310, the first vehicle 102a can identify that one of the new blocks includes the recall notification message submitted by the manufacturer system 108. In step 312, the first vehicle 102a can transmit the recall notification message to the user interface display 208, which can then display the recall notification message to the vehicle owner and/or operator.

Subsequent to the first vehicle 102a updating its local copy of the blockchain in step 308, the second vehicle 102b can be in operation and in a proximity to the first vehicle 102a such that the first vehicle 102a and the second vehicle 102b can communicate using a suitable communication method. In step 314, a transmitting device 222 of the computing device 200 of the second vehicle 102b can broadcast a message that includes identification data for the second vehicle 102b, such as the make and model of the second vehicle 102b and a timestamp of the latest update to its local copy of the blockchain in its blockchain data 206. In step 316, a receiving device 202 of the computing device 200 of the first vehicle 102a can receive the broadcast message from the second vehicle 102b.

In step 318, the querying module 216 of the computing device 200 of the first vehicle 102a can execute a query on its blockchain data 206 to identify any blocks added to its local copy of the blockchain since the timestamp indicated in the second vehicle's broadcast message. In step 320, the transmitting device 222 of the computing device 200 of the first vehicle 102a can electronically transmit updated blockchain data to the second vehicle 102b that includes the identified blocks that had been added to the blockchain since the second vehicle's last update. In step 322, the receiving device 202 of the computing device 200 of the second vehicle 102b can receive the updated blockchain data.

In step 324, the querying module 216 of the computing device 200 of the second vehicle 102b can execute a query on its blockchain data 206 to update its blockchain data 206 to store the newly added blocks received in the updated blockchain data. In step 326, the second vehicle 102b can identify that one of the new blocks includes the recall notification message submitted by the manufacturer system 108. In step 328, the second vehicle 102b can transmit the recall notification message to the user interface display 208, which can then display the recall notification message to the vehicle owner and/or operator. As a result, the vehicle owner of the second vehicle 102b can quickly be informed of the recall without requiring the vehicle manufacturer to contact every targeted vehicle owners and with the second vehicle 102b only requiring a direct vehicle-to-vehicle communication.

### Exemplary Method for Data Exchange Between Vehicles Using Blockchain

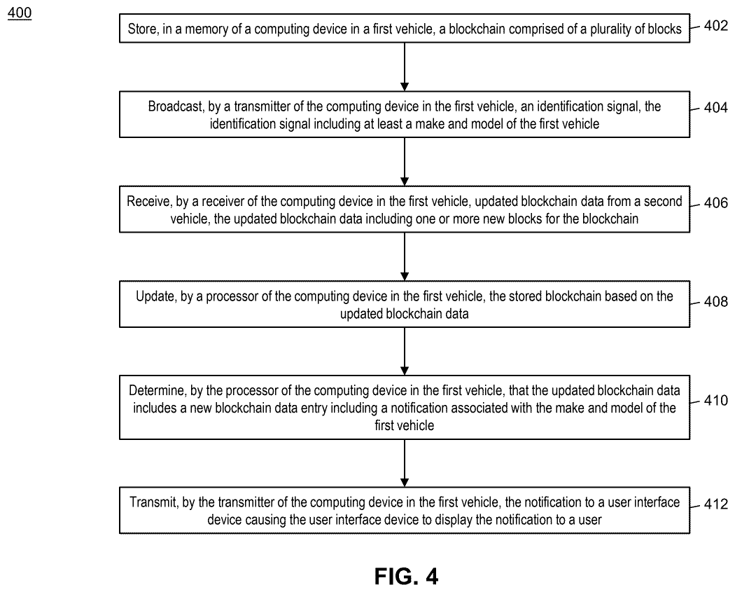

FIG. 4 illustrates a method 400 for the exchange of blockchain data between two vehicles including an applicable notification for display to a user.

In step 402, a blockchain comprised of a plurality of blocks can be stored in a memory (e.g., blockchain data 206, memory 214, etc.) of a computing device (e.g., computing device 200) in a first vehicle (e.g., first vehicle 102a). In step 404, an identification signal can be broadcast by a transmitter (e.g., transmitting device 222) off the computing device of the first vehicle, the identification signal including at least a make and model of the first vehicle. In step 406, updated blockchain data can be received by a receiver (e.g., receiving device 202) of the computing device in the first vehicle from a second vehicle (e.g., second vehicle 102b), the updated blockchain data including one or more new blocks for the blockchain.

In step 408, the stored blockchain can be updated by a processor (e.g., querying module 216) of the computing device of the first vehicle based on the updated blockchain data. In step 410, the processor of the computing device in the first vehicle can determine that the updated blockchain data includes a new blockchain data entry including a notification associated with the make and model of the first vehicle. In step 412, the notification can be transmitted by the transmitter of the computing device in the first vehicle to a user interface device (e.g., user interface display 208) causing the user interface device to display the notification to a user.

In one embodiment, the second vehicle can be of the same make and model as the first vehicle. In some embodiments, the notification can indicate a recall affecting the make and model of the first vehicle. In one embodiment, the broadcast signal can further include a timestamp associated with the stored blockchain. In a further embodiment, the updated blockchain data can include one or more new blocks added to the blockchain identified based on the timestamp.

In some embodiments, the blockchain can include a blockchain data entry including at least one of a vehicle identification number, registration number, license plate number, odometer reading, and registration state associated with the first vehicle. In one embodiment, the user interface device can be a physical display integrated with the first vehicle. In some embodiments, the user interface device can be a handheld computing device of the user separate from the computing device in the first vehicle.

### Computer System Architecture

FIG. 5 illustrates a computer system 500 in which embodiments of the present disclosure, or portions thereof, can be implemented as computer-readable code. For example, the vehicles 102, blockchain nodes 106, manufacturer system 108, regulatory agency 110, and computing device 200 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3A, 3B, and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for data exchange between vehicles using blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for data exchange between vehicles using blockchain, comprising:
storing, in a memory of a computing device in a first vehicle, a blockchain comprised of a plurality of blocks;
broadcasting, by a transmitter of the computing device in the first vehicle, an identification signal, the identification signal including data identifying at least a make and model of the first vehicle;
receiving, by a receiver of the computing device in the first vehicle, updated blockchain data from a second vehicle, the updated blockchain data including one or more new blocks for the blockchain;
updating, by a processor of the computing device in the first vehicle, the stored blockchain based on the updated blockchain data;
determining, by the processor of the computing device in the first vehicle, that the updated blockchain data includes a new blockchain data entry including a notification associated with the make and model of the first vehicle; and
transmitting, by the transmitter of the computing device in the first vehicle, the notification to a user interface device causing the user interface device to display the notification to a user.

2. The method of claim 1, wherein the second vehicle is of the same make and model as the first vehicle.

3. The method of claim 1, wherein the notification indicates a recall affecting the make and model of the first vehicle.

4. The method of claim 1, wherein the broadcast signal further includes a timestamp associated with the stored blockchain.

5. The method of claim 4, wherein the updated blockchain data includes one or more new blocks added to the blockchain identified based on the timestamp.

6. The method of claim 1, wherein the blockchain includes a blockchain data entry including at least one of a vehicle identification number, registration number, license plate number, odometer reading, and registration state associated with the first vehicle.

7. The method of claim 1, wherein the user interface device is a physical display integrated with the first vehicle.

8. The method of claim 1, wherein the user interface device is a handheld computing device of the user separate from the computing device in the first vehicle.

9. The method of claim 1, wherein the data identifying at least a make and model is data identifying at least one of: 1) make and model and 2) a blockchain that is dedicated to a particular make, certain makes, certain makes and certain models, make and model, specific sets of Vehicle Identification Numbers (VINs).

10. A system for data exchange between vehicles using blockchain, comprising:
a first vehicle;
a second vehicle; and
a user interface device, wherein
the first vehicle includes computing device, the computing device comprising
a memory storing a blockchain comprised of a plurality of blocks,
a transmitter broadcasting an identification signal, the identification signal including data identifying at least a make and model of the first vehicle,
a receiver receiving updated blockchain data from the second vehicle, the updated blockchain data including one or more new blocks for the blockchain,
a processor updating the stored blockchain based on the updated blockchain data, and determining that the updated blockchain data includes a new blockchain data entry including a notification associated with the make and model of the first vehicle, wherein
the transmitter of the computing device of the first vehicle further transmits the notification to the user interface device causing the user interface device to display the notification to a user.

11. The system of claim 10, wherein the second vehicle is of the same make and model as the first vehicle.

12. The system of claim 10, wherein the notification indicates a recall affecting the make and model of the first vehicle.

13. The system of claim 10, wherein the broadcast signal further includes a timestamp associated with the stored blockchain.

14. The system of claim 13, wherein the updated blockchain data includes one or more new blocks added to the blockchain identified based on the timestamp.

15. The system of claim 10, wherein the blockchain includes a blockchain data entry including at least one of a vehicle identification number, registration number, license plate number, odometer reading, and registration state associated with the first vehicle.

16. The system of claim 10, wherein the user interface device is a physical display integrated with the first vehicle.

17. The system of claim 10, wherein the user interface device is a handheld computing device of the user separate from the computing device in the first vehicle.

18. The system of claim 10, wherein the data identifying at least a make and model is data identifying at least one of: 1) make and model and 2) a blockchain that is dedicated to a particular make, certain makes, certain makes and certain models, make and model, specific sets of Vehicle Identification Numbers (VINs).
